(19) United States
(12) Patent Application Publication
(10) Pub. No.: US 2010/0095358 A1
(43) Pub. Date: Apr. 15, 2010

(54) Method and Base Station for Creating an Account in a Network Featuring a VoIP Protocol for DECT Mobile Parts

(75) Inventors: Anton Kruk, Hamminkeln (DE); Christoph Lenfort, Bocholt (DE)

Correspondence Address: FENWICK & WEST LLP, SILICON VALLEY CENTER, 801 CALIFORNIA STREET, MOUNTAIN VIEW, CA, 94041, US

(73) Assignee: GIGASET COMMUNICATIONS GMBH, Munich (DE)

(21) Appl. No.: 12/525,247

(22) PCT Filed: Mar. 3, 2008
(86) PCT No.: PCT/EP08/52542

§ 371 Date: Jul. 30, 2009

(30) Foreign Application Priority Data
Mar. 5, 2007 (DE) 102007010582.9

(51) Int. Cl. G06F 21/00

(52) U.S. Cl. 726/6

(57) ABSTRACT

When registering a DECT mobile part (MT) with the base station (BS), the VoIP user ID (user) is formed from the DECT user ID (IPUI) according to a mapping rule and is used for registering an SIP account (SIPA). In addition, the SIP password (pw(AC)) is formed from the DECT authentication code (AC). Roaming or handover of DECT mobile parts (MT) in DECT systems featuring a VoIP connection can be accomplished in a simple manner by adjusting the DECT user ID (IPUI) to the SIP user ID (user (IPUI)) and adjusting the authentication code (AC) to the password (pw(AC)). The DECT mobile parts (MT) can continue to be used without change even when the same are connected to IP-oriented networks (IN), while said DECT mobile parts (MT) can be marketed for a wider range of uses.

Procedure and base station for creating an account in a network featuring a VoIP protocol for DECT mobile parts.

In wireless multicell systems, particularly in DECT multicell systems, identification between DECT mobile parts and the DECT base station is controlled through allocation of access rights. According to ETSI Standard 300 175 (Digital Enhanced Cordless Telecommunications), each base station has a unique worldwide access rights identity (ARI). Each mobile station identifies itself via an access key, Portable Access Rights Key (PARK), together with an international user identification, the International Portable User Identification (IPUI). The identification system for a mobile station is designed to search for a DECT base station valid for it and then unambiguously to identify the mobile station itself within the network. The mobile station can register with a base station only if its ARI is recognized by one of its PARKs. This is the function of the Portable Access Rights Key (PARK) and the International Portable User Identity (IPUI). A mobile station should have at least one PARK and one IPUI. This function is also required for roaming and handover of mobile components from base station to base station, since this is designed to allow other base stations to identify the roaming mobile component and then establish whether it is authorized for a particular base station.

Furthermore, a DECT standard authentication code is required for registration of a DECT mobile component with an assigned base station for unambiguous authentication for registration with the base station—described as an “authentication code” in the standard. The authentication code will ordinarily be preset and then for security purposes changed at registration. In the context of authentication between mobile components and a base station, this authentication code functions as a password of the DECT subscriber.

For some time now, DECT mobile components have been provided for connection to an intranet or the Internet, for which the base station performs a DECT/SIP (Session Internet Protocol) conversion. For voice communications via networks with Internet Protocol (referred to in the professional world as Voice over IP (VoIP)), the SIP protocol (Session Initiation Protocol) is the protocol most often provided. For roaming or handover of DECT mobile components, an SIP account is assigned to the home system in an assigned server. An SIP account is usually formed from a user identification or user name and a password. This means that an SIP account will be entered from a DECT mobile component to provide unambiguous identification to the SIP server for every base station of the system.

The underlying object of the present invention is to provide an improved means of creating SIP accounts in DECT cordless systems with SIP conversion. It accomplishes this object by virtue of the features described in claims 1 and 7.

An essential aspect of the method according to the invention can be seen in the fact that within the context of the registration of the DECT mobile component with the base station, the latter acquires the DECT user identification and, in accordance with a mapping rule or format and protocol adjustment, uses it as the SIP user identification to create the account. For authentication between the DECT mobile component and the base station, the DECT mobile component and the base station share an authentication code AC as a common secret. In a useful embodiment of the method according to the invention, an SIP password can also be derived from this authentication code AC.

An important advantage of the invention can be seen in that, without further development or modification, the DECT mobile components can be used for base stations with DECT/SIP protocol conversion or VoIP communications and so permit particularly economical realization of DECT/VoIP mobile components with VoIP roaming. The mobile components can also be marketed for a broad range of applications. A further advantage consists in the fact that it is not necessary to store and administer different user IDs, passwords or authentication information.

Other useful embodiments of the method according to the invention and the configuration of a base station according to the invention can be visualized from the other claims.

The invention and modifications and improvements upon it are illustrated in the two diagrams below. They show the following:

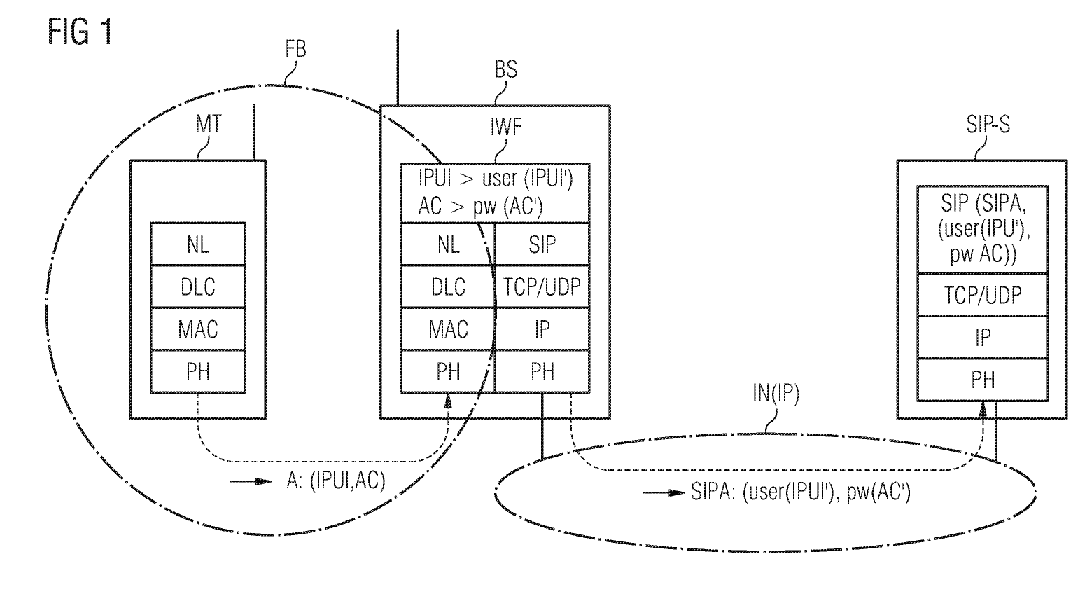

FIG. 1. diagram of a communication system showing the planes in the components

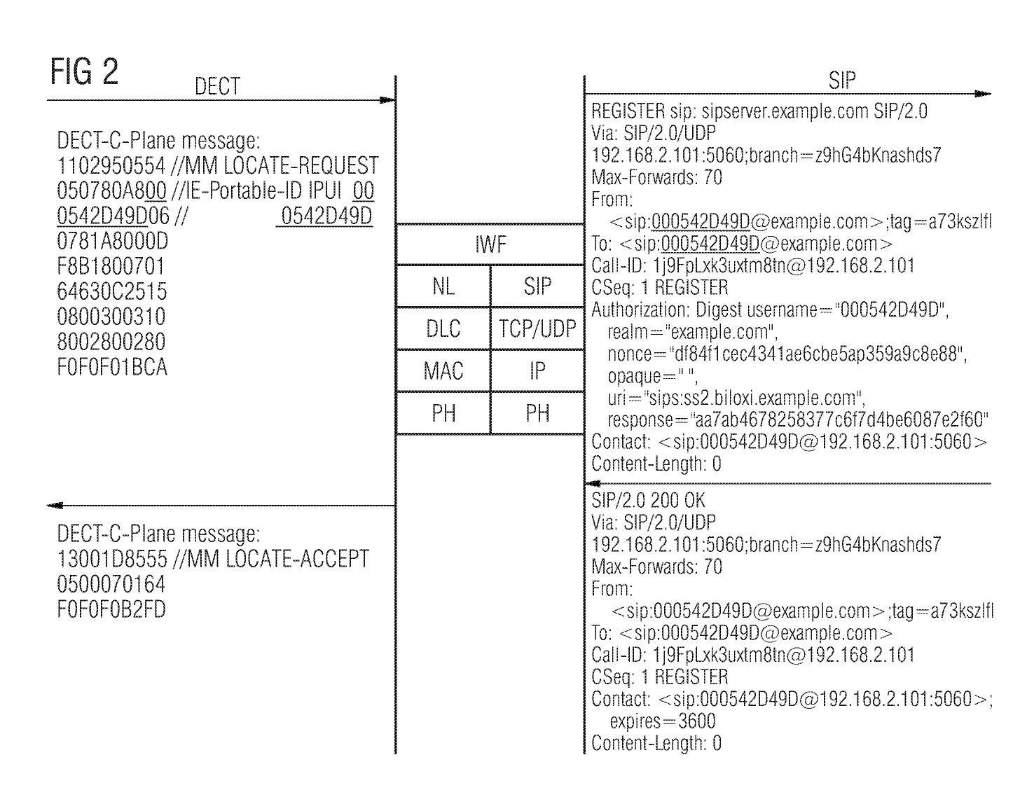

FIG. 2. the method according to the invention as applied in a communication system illustrated on the basis of a flow diagram.

FIG. 1 shows a DECT base station BS to which cordless DECT mobile components MT can be connected in accordance with the DECT standard. For purposes of this embodiment is shown, by way of example, a DECT mobile component MT, which is connected to the DECT base station BS by means of a cordless link. The associated radio cell, or the radio range FB, is represented in FIG. 1 by dot-dash circle FB. The base station BS is also linked to a communication network IN with Internet Protocol IP, where the communication network can be represented by an intranet or the Internet IN. In the exemplary embodiment let the communication network be represented by the Internet IN. The SIP (Session Internet Protocol) Protocol is provided for the exemplary embodiment as protocol for VoIP (Voice over Internet communications), or voice, communications via the Internet IN. In the Internet IN the SIP Protocol SIP is implemented in an SIP server SIPS and is represented in FIG. 1 by a rectangle designated SIP.

The SIP Protocol was developed with regard to the Internet and is geared toward the architecture of current Internet applications. This places a premium on easy implementability, scalability, expandability and flexibility. The SIP Protocol can be used to administer any session or communication connections with one or several subscribers. For roaming or handover of VoIP communications an SIP server SIPS is integrated in the Internet IN, in which an SIP account is created for a DECT mobile component MT (designated in FIG. 1 as SIPA to indicate SIP). An SIP account SIPA is usually represented by an SIP user identification (the user name ordinarily) and an SIP password. After an SIP account SIPA is created, the authentication of the SIP end user device will be verified as the connection of the SIP end user device is established.

The DECT mobile component MT communicates with the DECT base station BS in accordance with the DECT protocol implemented according to ETSI Standard 300 175. To permit VoIP communication between the DECT mobile component and the communication network IN, which is provided with the SIP protocol SIP, the base station will be implemented with a DECT/SIP protocol conversion.

The DECT protocol, SIP protocol and the protocol conversion are illustrated in FIG. 1 by a protocol layering diagram, which applies to the protocol layers as well as to the DECT mobile component MT, the DECT base station BS and the SIP server SIPS.

In both protocol layers, base is the physical layer PH. The physical layer PH of the DECT protocol is provided with the wireless interface and the access method. It is in the access layer, or Medium Access Control layer MAC, that the radio channel is selected and control information for the establishment, reconfiguration and disestablishment of the radio channel and the synchronization information are transmitted. The user and signaling data to be transmitted are also encoded there. In the data link layer, or Data Link Control layer DLC, the information to be transmitted is packed into packets. If necessary, these will also include checksums and control information for the data stream. The network layer NL controls information exchange for establishing and terminating the connection, or the signaling. The DECT mobile component MT is implemented with a similar layered protocol structure as well.

The physical layer PH, or the network layer, of the SIP protocol SIP incorporates the transmission medium, or the network (e.g., Ethernet), as well as the methods to be used to access the transmission medium, or network (e.g., CSMA). The adjacent Internet layer is implemented with the Internet Protocol IP in accordance with the IPv4 or IPv6 standards used. The next layer, the transport layer, uses a Transmission Control Protocol TCP or a User Datagram Protocol UDP in accordance with the SIP standard governing transmission of signaling information. As a rule, to transmit voice information the User Datagram Protocol is used. The SIP Protocol is implemented in the next layer and usefully configured in accordance with IETF Standard RFC 3261. The SIP server is implemented with a similarly configured layered structure as well. In this regard see also FIG. 1.

In the base station BS, an interworking function IWF is placed between the two protocols. This interworking function IWF extracts the signaling information and user information from the DECT Protocol and adjusted to the formats and protocol contents. Following format and protocol adjustment, the adjusted signaling information will then be integrated into the SIP protocol and reversed in accordance with protocol requirements.

To permit unambiguous authentication of the subscriber, an International Portable User Identity (hereinafter designated as IPUI) is used. This will be unambiguously defined for an approved range, in one or several base station areas, represented by Portable Access Rights Keys (PARK). An IPUI is formed from information indicating the type of user and information indicating a user number. The length of the user number depends here on the user type employed (e.g., ISDN, PBX).

For unambiguous authentication of the DECT mobile component MT vis-à-vis the base station BS, during the process of registering the DECT mobile component MT with, or subscription of the DECT mobile component MT to, the DECT base station BS, a DECT standard authentication code AC (described as “authentication code” in DECT Standard 300 175) will be entered. For registration purposes, of course, the authentication code AC has been preestablished, but for security reasons it will be changed, i.e., reentered.

In DECT mobile components, for example, which are currently activated, i.e., currently enabled, or “roaming,” i.e., changing radio coverage areas, following reception of a radio fixed part identity message the accompanying identification (PARK) will be compared with a stored identification, the stored identification (PARK) indicating that the communication end device is permitted to access the area, or its base station BS. If an appropriate identification has been stored, the associated identification unambiguously assigned to the DECT mobile component (IPUI) is included in a location registration message and sent to the base station BS or the area. This location registration message then permits registration of the DECT mobile component MT in the area or its base station BS.

For roaming or handover of DECT mobile components MT, an SIP account SIPA will be assigned to the home system in the assigned SIP server SIPS. SIP accounts are usually formed from a user identification user or user name and a password pw. This means that the DECT mobile component must enter an SIP account SIPA to be able to unambiguously identify itself vis-à-vis the SIP server SIPS.

The present invention makes it possible to dispense with the entry of a user identification user and a password pw. This is achieved by virtue of the fact that in the registration procedure (indicated in the figure by A:) the IPUI transmitted is used as user identification user to create an SIP account SIPA in accordance with a mapping rule. The SIP password pw is formed from the authentication code AC known from the DECT authentication. The IPUI and the authentication code AC will accordingly be captured in the network layer NL of the DECT base station BS and transmitted to the interworking function IWP. Here both items of information, IPUI and AC, will be adjusted to the formats used in the SIP protocol SIP in accordance with a mapping rule and then, in accordance with the SIP protocol, used as adjusted user identification user (IPUI′) and password pw (AC′) and transferred to the SIP protocol layer SIP. Then here, both items of information thus formed and adjusted, user (IPUI′) and pw (AC), will be used as SIP account data to create an SIP account for the mobile component MT.

By way of example, FIG. 2 shows how the interworking function IWF converts an incoming MM-LOCATE-REQUEST message from the DECT protocol to a REGISTER message for the SIP protocol. Here, according to the invention, a mapping function forms the SIP user identification user from the DECT user identification IPUI, which in this example is “000542D49D”. In this example, the mapping function is configured such that the SIP user identification user is identical to the DECT user identification IPUI. But it would be possible to conceive of other mapping rules. For example, the SIP user identification user could be the octal representation of the DECT user identification. In this example, the DECT user identification IPUI=“000542D49D” would then become the SIP user identification user “520552235”. Other mapping rules are also possible, whereby from the DECT user identification IPUI, the SIP user identification user can be generated directly with the mapping rule without SIP user identifications stored by the base station BS.

The adjustment of the IPUI to the user identification user (IPUI′) and of the authentication code AC to the password pw (AC′) proposed in the present invention permits simple implementation of roaming and handover of DECT mobile components MT in DECT systems featuring a VoIP connection, whereby, on the one hand, DECT mobile components MT can continue to be used without change even when connected to IP-oriented networks and, on the other, these components can be marketed for a broader ranges of uses.

What is claimed is:

1. Method for creating an account in a network (IN) with VoIP Protocol for a DECT mobile component (MT) of a DECT base station (BS) with a DECT/VoIP protocol conversion for VoIP communications characterized in that the VoIP user identification (user) is formed from the DECT user identification (IPUI) in accordance with a mapping rule.

2. Method according to claim 1 characterized in that the VoIP password pw is formed from the DECT authentication code AC.

3. Method according to claim 1 characterized in that the account thus generated will be created as an SIP account (SIPA) in the network (IN) with VoIP protocol for the DECT mobile component (MT).

4. Method according to claim 3 characterized in that the SIP account (SIPA) is created in an SIP server (SIPS) in the network (IN).

5. Method according to claim 1 characterized in that the DECT user identification (IPUI) and the authentication code (AC) are generated in accordance with ETSI Standard 300 175.

6. Method according to claim 1 characterized in that the account thus generated is created through an H.323 account in the network (IN) with IP Protocol for the DECT mobile component (MT).

7. Base station for creating an account in a network with VoIP protocol for a DECT mobile component (MT) at the base station (BS) with a DECT/VoIP protocol conversion for VoIP communication characterized in that an interworking function (IWF) is provided to generate a VoIP user identification (user) from the DECT user identification (IPUI) in accordance with a mapping rule.

8. Base station according to claim 7 characterized in that the interworking function (IWF) that generates the VoIP password pw is formed from the DECT authentication code AC.

9. Base station according to claim 7 characterized in that the VoIP Protocol is generated as SIP protocol (SIP), whereby the account thus formed is created as SIP account (SIPA) in the network with VoIP Protocol.

10. Base station according to claim 7 characterized in that the DECT user identification (IPUI) and the authentication code (AC) are represented in accordance with ETSI Standard 300 175.

11. Method according to claim 7 characterized in that the VoIP Protocol is generated as H.323 protocol, whereby the account is created as H.323 account in the network with VoIP Protocol.
